(19) United States
(12) Patent Application Publication
(10) Pub. No.: US 2023/0041050 A1
(43) Pub. Date: Feb. 9, 2023

(54) LOW VOLATILE POLYAMINE SALTS OF ANIONIC PESTICIDES

(71) Applicant: BASF CORPORATION, Florham Park, NJ (US)

(72) Inventors: Klaus Kolb, Schifferstadt (DE); Michael Krapp, Limburgerhof (DE); Wolfgang Gregori, Ludwigshafen (DE); Matthias Bratz, Limburgerhof (DE); Marc Nolte, Limburgerhof (DE); Ansgar Gereon Altenhoff, Ludwigshafen (DE); Steven Joseph Bowe, Research Triangle Park, NC (US); Sanjeev Kumar Bangarwa, Research Triangle Park, NC (US); Anja Simon, Weinheim (DE)

(21) Appl. No.: 17/784,166

(22) PCT Filed: Dec. 10, 2020
(86) PCT No.: PCT/EP2020/085447

§ 371 Date: Jun. 10, 2022

(30) Foreign Application Priority Data
Dec. 20, 2019 (EP) 19218633.6

(51) Int. Cl. A01N 33/04; A01N 37/40; A01N 57/20; A01P 13/00

(52) U.S. Cl. CPC A01N 33/04; A01N 37/40; A01N 57/20; A01P 13/00

(57) ABSTRACT

The present invention relates to a salt comprising an anionic pesticide (A) and a cationic polyamine of the formula (B) as described in the description. The invention further relates to an agrochemical composition comprising said salt. It also relates to a method for preparing said salt comprising combining the pesticide in its neutral form or as salt, and the polyamine in its neutral form or as salt. In addition, the invention relates to a method of combating harmful insects and/or phytopathogenic fungi. It also relates to a method of controlling undesired vegetation. Finally, the invention relates to seed comprising said salt.

The present invention relates to a salt comprising an anionic pesticide (A) and a cationic polyamine of the formula (B) as described below. The invention further relates to an agrochemical composition comprising said salt. In addition, the invention relates to a method of combating harmful insects and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of said agrochemical formulation. It also relates to a method of controlling undesired vegetation, which comprises allowing an herbicidal effective amount of said agrochemical formulation to act on plants, their habitat or on seed of said plants. Finally, the invention relates to seed comprising said salt. Combinations of preferred embodiments with other preferred embodiments are within the scope of the present invention.

Mitigation of off-target movement of pesticides (e.g. fungicides, herbicides or insecticides) from the treated area minimizes potential negative environmental effects and maximizes the efficacy where it is most needed. By their nature, herbicides affect sensitive plants and mitigating their off-target movement reduces their effect on neighboring crops and other vegetation, while max-imizing weed control in the treated field. Off-target movement can occur through a variety of mechanisms generally divided into primary loss (direct loss from the application equipment before reaching the intended target) and secondary loss (indirect loss from the treated plants and/or soil) categories.

Primary loss from spray equipment typically occurs as fine dust or spray droplets that take long-er to settle and can be more easily blown off-target by wind. Off-target movement of spray particles or droplets is typically referred to as ‘spray drift’. Primary loss can also occur when contaminated equipment is used to make an inadvertent application to a sensitive crop. Contamination may occur when one product (i.e. pesticide) is not adequately cleaned from spray equipment and the contaminated equipment is later used to apply a different product to a sensitive crop which may inadvertently result in crop injury.

Secondary loss describes off-target movement of a pesticide after it contacts the target soil and/or foliage and moves from the treated surface by means including airborne dust (e.g. crys-talline pesticide particles or pesticide bound to soil or plant particles), volatility (i.e. a change of state from the applied solid or liquid form to a gas), or run-off in rain or irrigation water.

Off-target movement is typically mitigated by proper application technique (e.g. spray nozzle selection, nozzle height and wind limitations) and improved pesticide formulation. This is also the case for dicamba where proper application technique mitigates potential primary loss and equipment contamination. Dicamba has a certain potential for secondary loss and this has been reduced through the development of formulations using improved dicamba salts such as dicam-ba-BAPMA. This invention describes methods that can provide additional reductions in potential secondary loss.

Various salts of anionic pesticides are known comprising cationic, amino-functionalized compounds.

EP 0 183 384 discloses a low volatility salt of dicamba, namely the 2-(2-aminoethoxy)ethanol salt.

U.S. Pat. No. 5,221,791 discloses aminoalkylpyrrolidone salts of pesticides comprising an acidic hydrogen, such as dicamba.

EP 2 482 654 discloses low volatility amine salts of anionic pesticides, wherein the amine is for example N,N-Bis(3-aminopropyl)methylamine (i.e. BAPMA), and agrochemical formulations comprising theses salts, which reduce undesired pesticide loss by evaporation.

WO2012/059494 discloses agrochemical compositions comprising identical polyamine salts of mixed anionic pesticides, for example the BAPMA salts of glyphosate and dicamba.

Although these pesticide salts have already a lowered volatility compared to the free acid forms of the pesticide, there is still a need to provide salts of pesticides showing lower volatility.

Object of the present invention was to provide salts of pesticides, which show a low volatility.

The object was resolved by a salt comprising an anionic pesticide (A) and a cationic polyamine of the formula (B)

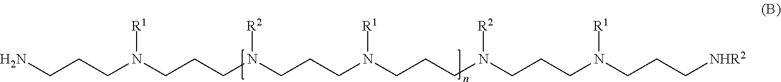

wherein R¹, R² are each independently H or C₁-C₆-alkyl, and n is between 5 to 40.

The term “salt” refers to chemical compounds, which comprise an anion and a cation. The ratio of anions to cations usually depends on the electric charge of the ions. Typically, salts dissociate when dissolved in water in anions and cations.

The term “pesticide” within the meaning of the invention states that one or more compounds can be selected from the group consisting of fungicides, insecticides, nematicides, herbicide and/or safener or growth regulator, preferably from the group consisting of fungicides, insecticides or herbicides, most preferably from the group consisting of herbicides. Also mixtures of pesticides of two or more the aforementioned classes can be used. The skilled artisan is familiar with such pesticides, which can be, for example, found in the Pesticide Manual, 13th Ed. (2003), The British Crop Protection Council, London.

The term “anionic pesticide” refers to a pesticide, which is present as an anion. Preferably, anionic pesticides relate to pesticides comprising an acidic hydrogen. More preferably, anionic pesticides relate to pesticides comprising a carboxylic, thiocarbonic, sulfonic, sulfinic, thiosulfonic or phosphorous acid group, especially a carboxylic acid group. The aforementioned groups may be partly present in neutral form including the acidic hydrogen.

Suitable anionic pesticides are given in the following. In case the names refer to a neutral form or a salt of the pesticide, the anionic form of the pesticides is meant.

Suitable anionic pesticides are herbicides, which comprise a carboxylic, thiocarbonic, sulfonic, sulfinic, thiosulfonic or phosphorous acid group, especially a carboxylic acid group. Examples are aromatic acid herbicides, phenoxycarboxylic acid herbicides or organophosphorus herbicides comprising a carboxylic acid group.

Suitable aromatic acid herbicides are benzoic acid herbicides, such as diflufenzopyr, naptalam, chloramben, dicamba, 2,3,6-trichlorobenzoic acid (2,3,6-TBA), tricamba; pyrimidinyloxybenzoic acid herbicides, such as bispyribac, pyriminobac; pyrimidinylthiobenzoic acid herbicides, such as pyrithiobac; phthalic acid herbicides, such as chlorthal; picolinic acid herbicides, such as aminopyralid, clopyralid, picloram; quinolinecarboxylic acid herbicides, such as quinclorac, quinmerac; or other aromatic acid herbicides, such as aminocyclopyrachlor. Preferred are benzoic acid herbicides, especially dicamba.

Suitable phenoxycarboxylic acid herbicides are phenoxyacetic herbicides, such as 4-chlorophenoxyacetic acid (4-CPA), (2,4-dichlorophenoxy)acetic acid (2,4-D), (3,4-dichlorophenoxy)acetic acid (3,4-DA), MCPA (4-(4-chloro-o-tolyloxy)butyric acid), MCPA-thioethyl, (2,4,5-trichlorophenoxy)acetic acid (2,4,5-T); phenoxybutyric herbicides, such as 4-CPB, 4-(2,4-dichlorophenoxy)butyric acid (2,4-DB), 4-(3,4-dichlorophenoxy)butyric acid (3,4-DB), 4-(4-chloro-o-tolyloxy)butyric acid (MCPB), 4-(2,4,5-trichlorophenoxy)butyric acid (2,4,5-TB); phenoxypropionic herbicides, such as cloprop, 2-(4-chlorophenoxy)propanoic acid (4-CPP), dichlorprop, dichlorprop-P, 4-(3,4-dichlorophenoxy)butyric acid (3,4-DP), fenoprop, mecoprop, mecoprop-P; aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop. Preferred are phenoxyacetic herbicides, especially 2,4-D and MCPA.

Suitable organophosphorus herbicides comprising a carboxylic acid group are bilanafos, glufosinate, L-glufosinate, glufosinate-P, glyphosate. Preferred is glyphosate.

Suitable other herbicides comprising a carboxylic acid are pyridine herbicides comprising a carboxylic acid, such as fluroxypyr, triclopyr; triazolopyrimidine herbicides comprising a carboxylic acid, such as cloransulam; pyrimidinylsulfonylurea herbicides comprising a carboxylic acid, such as bensulfuron, chlorimuron, foramsulfuron, halosulfuron, mesosulfuron, primisulfuron, sulfometuron.

Suitable anionic pesticides are fungicides, which comprise a carboxylic, thiocarbonic, sulfonic, sulfinic, thiosulfonic or phosphorous acid group, especially a carboxylic acid group. Examples are polyoxin fungicides, such as polyoxorim.

Suitable anionic pesticides are insecticides, which comprise a carboxylic, thiocarbonic, sulfonic, sulfinic, thiosulfonic or phosphorous acid group, especially a carboxylic acid group. Examples are thuringiensin.

Suitable anionic pesticides are plant growth regulator, which comprise a carboxylic, thiocarbonic, sulfonic, sulfinic, thiosulfonic or phosphorous acid group, especially a carboxylic acid group. Examples are 1-naphthylacetic acid, (2-naphthyloxy)acetic acid, indol-3-ylacetic acid, 4-indol-3-ylbutyric acid, glyphosine, jasmonic acid, 2,3,5-triiodobenzoic acid, prohexadione, trinexapac, preferably prohexadione and trinexapac.

Preferred anionic pesticides are anionic herbicides, more preferably dicamba, glyphosate, glufosinate, L-glufosinate, 2,4-D, aminopyralid, aminocyclopyrachlor and MCPA. In another embodiment, dicamba, glyphosate, glufosinate, L-glufosinate, 2,4-D, MCPA or mixture thereof are preferred. Especially preferred are dicamba and glyphosate. In another preferred embodiment, dicamba is preferred. In another preferred embodiment, 2,4-D is preferred. In another preferred embodiment, glyphosate is preferred. In another preferred embodiment, MCPA is preferred.

The term “polyamine” within the meaning of the invention relates to an organic compound with structure of formula (B).

The term “cationic polyamine” refers to a polyamine, which is present as cation. Preferably, in a cationic polyamine at least one amino group is present in the cationic form of an ammonium, such as R-N⁺H₃, R₂—N⁺H₂, or R₃—N⁺H.

A person skilled in the art is aware which of the amine groups in the cationic polyamine is preferably protonated, because this depends for example on the pH or the physical form. In aqueous solutions the alkalinity of the amino groups of the cationic polyamine increases usually from tertiary amine to primary amine to secondary amine.

In one embodiment, the polyamine in the present invention has the formula (B)

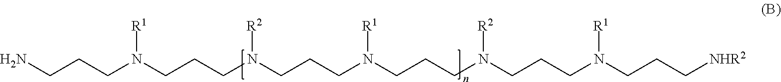

wherein R¹, R² are each independently H or C₁-C₆ alkyl, n is from 5 to 40. Preferably, R¹ and R² are each independently H or C₁-C₄ alkyl; more preferably R¹ and R² are each independently H or methyl and n is from 9 to 22; most preferably R¹ is methyl and R² is H, n is from 9 to 22. Examples for cationic polyamines of the formula (B) are formula B1, B2 and B3, wherein n is from 5 to 40, preferred 9 to 22.

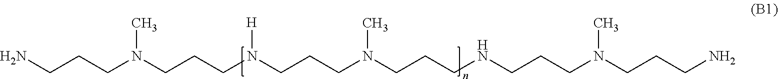

In cationic polyamines of the formula (B 1), R¹ is methyl and R² is hydrogen. n is from 5 to 40, preferred 9 to 22.

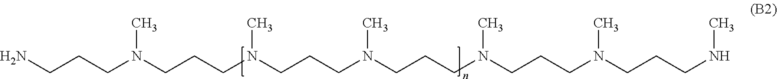

In cationic polyamines of the formula (B 2), R¹ is methyl and R² is methyl. n is from 5 to 40, preferred 9 to 22.

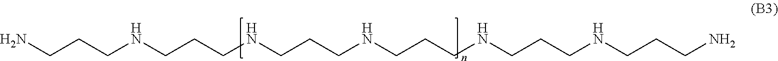

In cationic polyamines of the formula (B 3), R¹ is hydrogen and R² is hydrogen. n is from 5 to 40, preferred 9 to 22.

The polyamines of the formula (B) can be prepared by the method described in US2018201721A1 or are even commercially available.

The present invention also relates to a method for preparing the salt according to the invention comprising combining the pesticide in its neutral form or as salt, and the polyamine in its neutral form or as salt. The pesticide and the polyamine may be combined either neatly or with the compound in its available formulation, for example, dry or solid formulations as well as liquid formulations such as aqueous formulations. Preferably, the pesticide and the polyamine are contacted in water. More preferably, the pesticide or the polyamine, respectively, is neutralized in aqueous solution by addition of the polyamine or the pesticide, respectively. The water may be removed after the combining for isolation of the salt. The combination may be done at usual temperature for preparing salts, such as from −20° C. to 100° C.

The pesticide and the polyamine may be combined in a variety of molar ratios, which depend on the number of electric charges of the ions. For example, one mol of an anionic pesticides comprising one negative charge per mol is usually combined with one mol of cationic polyamine comprising one positive charge per mol. Preferably, the pesticide and the polyamine are combined in such a molar ratio which results to a pH of 6.0 to 10.0, preferably 6.5 to 9.0, more preferably 7.0 to 8.0, when the salt is present in water at 20° C. at a concentration of 600 g/I.

The present invention further relates to an agrochemical composition comprising the salt according to the invention. In the agrochemical composition according to the invention several anionic pesticides, such as two or three, may be present. For example, the composition may comprise at least two anionic pesticides selected from dicamba, quinclorac, glyphosate, 2,4-D, aminopyralid and MCPP. More preferably, it may comprise at least dicamba and glyphosate, 2,4-D and dicamba or dicamba and 2,4-D and MCPP.

The agrochemical composition may comprise at least one further pesticide. The further pesticide can be selected from the group consisting of fungicides, insecticides, nematicides, herbicide and/or safener or growth regulator, preferably from the group consisting of fungicides, insecticides or herbicides, more preferably herbicides. Preferred further pesticides are imidazoli-none herbicides and triazine herbicides.

The following list give examples of pesticides which may be used as further pesticide. Preferred pesticides from this list are those which are not anionic pesticides.

Examples for fungicides are:

A) strobilurines
azoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, tri-floxystrobin, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N-methyl-acetamide;

B) carboxamides
carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, met-alaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(3′,4′,5′-tri-fluorobiphenyl-2-yl)-3-difluoromethyl-1-methyl-1H-pyrazole-4-carboxamide, N-(4′-trifluoro-methylthiobiphenyl-2-yl)-3-difluoromethyl-1-methyl-1H-pyrazole-4-carboxamide and N-(2-(1,3,3-trimethyl-butyl)-phenyl)-1,3-dimethyl-5-fluoro-1H-pyrazole-4-carboxamide;
carboxylic morpholides: dimethomorph, flumorph, pyrimorph;
benzoic acid amides: flumetover, fluopicolide, fluopyram, zoxamide;
other carboxamides: carpropamid, dicyclomet, mandiproamid, oxytetracyclin, silthiofarm and N-(6-methoxy-pyridin-3-yl) cyclopropanecarboxylic acid amide;

C) azoles
triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole;
imidazoles: cyazofamid, imazalil, pefurazoate, prochloraz, triflumizol;
benzimidazoles: benomyl, carbendazim, fuberidazole, thiabendazole;
others: ethaboxam, etridiazole, hymexazole and 2-(4-chloro-phenyl)-N-[4-(3,4-dimethoxy-phenyl)-isoxazol-5-yl]-2-prop-2-ynyloxy-acetamide;

D) heterocyclic compounds
pyridines: fluazinam, pyrifenox, 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine;
pyrimidines: bupirimate, cyprodinil, diflumetorim, fenarimol, ferimzone, mepanipyrim, nitrapy-rin, nuarimol, pyrimethanil;
piperazines: triforine;
pyrroles: fenpiclonil, fludioxonil;
morpholines: aldimorph, dodemorph, dodemorph-acetate, fenpropimorph, tridemorph;
piperidines: fenpropidin;
dicarboximides: fluoroimid, iprodione, procymidone, vinclozolin;
non-aromatic 5-membered heterocycles: famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester;
others: acibenzolar-S-methyl, ametoctradin, amisulbrom, anilazin, blasticidin-S, captafol, captan, chinomethionat, dazomet, debacarb, diclomezine, difenzoquat, difenzoquat-methyl-sulfate, fenoxanil, Folpet, oxolinic acid, piperalin, proquinazid, pyroquilon, quinoxyfen, tri-azoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1-yl)-6-(2,4,6-trifluorophenyl)-[1,2,4]triazolo[1,5-a]pyrimidine;

E) carbamates
thio- and dithiocarbamates: ferbam, mancozeb, maneb, metam, methasulphocarb, metiram, propineb, thiram, zineb, ziram;
carbamates: benthiavalicarb, diethofencarb, iprovalicarb, propamocarb, propamocarb hydro-chlorid, valifenalate and N-(1-(1-(4-cyano-phenyl)ethanesulfonyl)-but-2-yl) carbamic acid-(4-fluorophenyl) ester;

F) other active substances
guanidines: guanidine, dodine, dodine free base, guazatine, guazatine-acetate, iminoctadine, iminoctadine-triacetate, iminoctadine-tris(albesilate);
antibiotics: kasugamycin, kasugamycin hydrochloride-hydrate, streptomycin, polyoxine, val-idamycin A;
nitrophenyl derivates: binapacryl, dinobuton, dinocap, nitrthal-isopropyl, tecnazen, organometal compounds: fentin salts, such as fentin-acetate, fentin chloride or fentin hydroxide;
sulfur-containing heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorothalonil, dichlofluanid, dichlorophen, flusulfamide, hexa-chlorobenzene, pencycuron, pentachlorphenole and its salts, phthalide, quintozene, thi-ophanate-methyl, tolylfluanid, N-(4-chloro-2-nitro-phenyl)-N-ethyl-4-methyl-benzenesulfonamide;
inorganic active substances: Bordeaux mixture, copper acetate, copper hydroxide, copper oxychloride, basic copper sulfate, sulfur;
others: biphenyl, bronopol, cyflufenamid, cymoxanil, diphenylamin, metrafenone, mildiomy-cin, oxin-copper, prohexadione-calcium, spiroxamine, tebufloquin, tolylfluanid, N-(cyclo-propylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide.

Examples for growth regulators are:

Abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapacethyl and uniconazole.

Examples for herbicides are:
acetamides: acetochlor, alachlor, butachlor, dimethachlor, dimethenamid, flufenacet, mefe-nacet, metolachlor, metazachlor, napropamide, naproanilide, pethoxamid, pretilachlor, propachlor, thenylchlor;
amino acid derivatives: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
Bipyridyls: diquat, paraquat;
(thio)carbamates: asulam, butylate, carbetamide, desmedipham, dimepiperate, eptam (EPTC), esprocarb, molinate, orbencarb, phenmedipham, prosulfocarb, pyributicarb, thio-bencarb, triallate;
cyclohexanediones: butroxydim, clethodim, cycloxydim, profoxydim, sethoxydim, tepraloxy-dim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfl uorfen;
hydroxybenzonitriles: bomoxynil, dichlobenil, ioxynil;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlorprop, MCPA, MCPA-thioethyl, MCPB, Mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfu-ron, triflusulfuron, tritosulfuron, 14(2-chloro-6-propyl-imidazo[1,2-b]pyridazin-3-yl)sulfonyl)-3-(4,6-dimethoxy-pyrimidin-2-yl)urea;
triazines: ametryn, atrazine, cyanazine, dimethametryn, ethiozin, hexazinone, metamitron, metribuzin, prometryn, simazine, terbuthylazine, terbutryn, triaziflam;
ureas: chlorotoluron, daimuron, diuron, fluometuron, isoproturon, linuron, metha-benzthiazuron, tebuthiuron;
other acetolactate synthase inhibitors: bispyribacsodium, cloransulam-methyl, diclosulam, florasulam, flucarbazone, flumetsulam, metosulam, ortho-sulfamuron, penoxsulam, pro-poxycarbazone, pyribambenz-propyl, pyribenzoxim, pyriftalid, pyriminobacmethyl, pyrimisul-fan, pyrithiobac, pyroxasulfone, pyroxsulam;
others: amicarbazone, aminotriazole, anilofos, beflubutamid, benazolin, bencarbazo-ne,benfluresate, benzofenap, bentazone, benzobicyclon, bicyclopyrone, bromacil, bromobu-tide, butafenacil, butamifos, cafenstrole, carfentrazone, cinidon-ethlyl, chlorthal, cinmethylin, clomazone, cumyluron, cyprosulfamide, dicamba, difenzoquat, diflufenzopyr, Drechslera monoceras, endothal, ethofumesate, etobenzanid, fenoxasulfone, fentrazamide, flumicloracpentyl, flumioxazin, flupoxam, flurochloridone, flurtamone, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyra-flufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methyl-phenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester.

Examples for insecticides are:
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodi-carb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
nicotinic receptor agonists/antagonists compounds: clothianidin, dinotefuran, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane;
GABA antagonist compounds: endosulfan, ethiprole, fipronil, vaniliprole, pyrafluprole, pyri-prole, 5-amino-1-(2,6-dichloro-4-methyl-phenyl)-4-sulfinamoyl-1H-pyrazole-3-carbothioic acid amide;
macrocyclic lactone insecticides: abamectin, emamectin, milbemectin, lepimectin, spinosad, spinetoram;
mitochondrial electron transport inhibitor (METI) I acaricides: fenazaquin, pyridaben, tebufenpyrad, tolfenpyrad, flufenerim;
METI II and III compounds: acequinocyl, fluacyprim, hydramethylnon;
Uncouplers: chlorfenapyr;
oxidative phosphorylation inhibitors: cyhexatin, diafenthiuron, fenbutatin oxide, propargite;
moulting disruptor compounds: cryomazine;
mixed function oxidase inhibitors: piperonyl butoxide;
sodium channel blockers: indoxacarb, metaflumizone;
others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluron, and pyrifluquinazon.

The compositions according to the invention are suitable as herbicides. They are suitable as such or as an appropriately formulated composition. The compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

Depending on the application method in question, the compositions according to the invention can additionally be employed in a further number of crop plants for eliminating undesirable plants. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Brassica juncea, Brassica campestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vi-nifera, Zea mays.

The compositions according to the invention can also be used in genetically modified plants, e.g. to alter their traits or characteristics. The term “genetically modified plants” is to be under-stood as plants, which genetic material has been modified by the use of recombinant DNA techniques in a way that under natural circumstances it cannot readily be obtained by cross breeding, mutations, natural recombination, breeding, mutagenesis, or genetic engineering. Typically, one or more genes have been integrated into the genetic material of a genetically modified plant in order to improve certain properties of the plant. Such genetic modifications also include but are not limited to targeted post-transtional modification of protein(s), oligo- or polypeptides e. g. by glycosylation or polymer additions such as prenylated, acetylated or famesylated moieties or PEG moieties.

Furthermore, plants are also covered that are by the use of recombinant DNA techniques capable to synthesize one or more insecticidal proteins, especially those known from the bacterial genusBacillus,particularly fromBacillus thuringiensis,such as äendotoxins, e. g. CrylA(b), Cry-IA(c), CryIF, CryIF(a2), CryllA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, e. g.Photorhabdusspp. orXenorhabdusspp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bry-odin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chi-tinases or glucanases. In the context of the present invention these insecticidal proteins or toxins are to be under-stood expressly also as pre-toxins, hybrid proteins, truncated or otherwise modified proteins. Hybrid proteins are characterized by a new combination of protein domains, (see, e. g. WO 02/015701). Further examples of such toxins or genetically modified plants capable of synthesizing such toxins are dis-closed, e. g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e. g. in the publications mentioned above. These insecticidal proteins contained in the genetically modified plants impart to the plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified plants capable to synthesize one or more insecticidal pro-teins are, e. g., described in the publications mentioned above, and some of which are commercially available such as YieldGard<®>(corn cultivars producing the CrylAb toxin), YieldGard<®>Plus (corn cultivars producing CrylAb and Cry3Bb1 toxins), Starlink<®>(corn cultivars producing the Cry9c toxin), Herculex<®>RW (corn cultivars producing Cry34Ab1, Cry35Ab1 and the enzyme Phosphinothricin-N-Acetyltransferase [PAT]); NuCOTN<®>33B (cotton cultivars producing the CrylAc toxin), Bollgard<®>1 (cotton cultivars producing the CrylAc toxin), Bollgard<®>11 (cotton cultivars producing CrylAc and Cry2Ab2 toxins); VIPCOT<®>(cotton cultivars producing a VIP-toxin); NewLeaf<®>(potato cultivars producing the Cry3A toxin); Bt-Xtra<®>, NatureGard<®>, KnockOut<®>, BiteGard<®>, Protecta<®>, Bt11 (e. g. Agrisure<®>CB) and Bt176 from Syn-gents Seeds SAS, France, (corn cultivars producing the CrylAb toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars produ-cing the Cry3Bb1 toxin), IPC 531 from Monsanto Europe S.A., Belgium (cotton cultivars producing a modified version of the CrylAc toxin) and 1507 from Pioneer Overseas Corpora-tion, Belgium (corn cultivars producing the CrylF toxin and PAT enzyme).

The compositions according to the invention are applied to the plants mainly by spraying the leaves. Here, the application can be carried out using, for example, water as carrier by customary spraying techniques using spray liquor amounts of from about 100 to 1000 I/ha (for example from 300 to 400 I/ha). The herbicidal compositions may also be applied by the low-volume or the ultra-low-volume method, or in the form of microgranules.

The herbicidal compositions according to the present invention can be applied pre- or post-emergence, or together with the seed of a crop plant. It is also possible to apply the compounds and compositions by applying seed, pretreated with a composition of the invention, of a crop plant. If the compositions according to the invention are less well tolerated by certain crop plants, application techniques may be used in which the herbicidal compositions are sprayed, with the aid of the spraying equipment, in such a way that as far as possible they do not come into contact with the leaves of the sensitive crop plants, while the compositions according to the invention reach the leaves of undesirable plants growing underneath, or the bare soil surface (post-directed, lay-by).

In a further embodiment, the composition according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds of the formula I according to the invention or the compositions prepared therefrom. Here, the herbicidal compositions can be applied diluted or undiluted.

The term seed comprises seed of all types, such as, for example, corns, seeds, fruits, tubers, seedlings and similar forms. Here, preferably, the term seed describes corns and seeds. The seed used can be seed of the useful plants mentioned above, but also the seed of transgenic plants or plants obtained by customary breeding methods.

The rates of application of the compositions according to the invention are from 0.0001 to 3.0, preferably 0.01 to 1.0 kg/ha of active substance (a.s.), depending on the control target, the sea-son, the target plants and the growth stage. To treat the seed, the compounds I are generally employed in amounts of from 0.001 to 10 kg per 100 kg of seed.

The salts according to the invention can be converted into customary types of agrochemical compositions, e. g. solutions, emulsions, suspensions, dusts, powders, pastes and granules. The composition type depends on the particular intended purpose; in each case, it should ensure a fine and uniform distribution of the compound according to the invention. Examples for composition types are suspensions (SC, OD, FS), emulsifiable concentrates (EC), emulsions (EW, EO, ES), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF). Usually the composition types (e. g. SC, OD, FS, EC, WG, SG, WP, SP, SS, WS, GF) are employed diluted. Composition types such as DP, DS, GR, FG, GG and MG are usually used undiluted. The compositions are prepared in a known manner.

The agrochemical compositions may also comprise auxiliaries which are customary in agrochemical compositions. The auxiliaries used depend on the particular application form and active substance, respectively. Examples for suitable auxiliaries are solvents, solid carriers, dispersants or emulsifiers (such as further solubilizers, protective colloids, surfactants and adhe-sion agents), organic and inorganic thickeners, bactericides, anti-freezing agents, anti-foaming agents, if appropriate colorants and tackifiers or binders (e. g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e. g. toluene, xylene, paraffin, tetra-hydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e. g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas, and products of vegetable origin, such as ce-real meal, tree bark meal, wood meal and nutshell meal, cellulose powders and other solid carriers.

Suitable surfactants (adjuvants, wtters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Mor-wet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phe-nol and formaldehyde, polyoxy-ethylene octylphenyl ether, ethoxylated isooctylphenol, octylphenol, nonylphenol, alkylphenyl polyglycol ethers, tributylphenyl polyglycol ether, tristearyl-phenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e. g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers therof.

Examples for thickeners (i. e. compounds that impart a modified flowability to compositions, i. e. high viscosity under static conditions and low viscosity during agitation) are polysaccharides and organic and anorganic clays such as Xanthan gum (Kelzan®, CP Kelco, U.S.A.), Rhodo-pol® 23 (Rhodia, France), Veegum® (R.T. Vanderbilt, U.S.A.) or Attaclay® (Engelhard Corp., NJ, USA). Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie). Examples for suitable anti-freezing agents are ethylene glycol, propylene glycol, urea and glycerin. Examples for anti-foaming agents are silicone emulsions (such as e. g. Silikon® SRE, Wacker, Germany or Rhodorsil®, Rhodia, France), long chain alcohols, fatty acids, salts of fatty acids, fluoroorganic compounds and mixtures thereof. Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding the salts according to the invention and, if appropriate, further active substances, with at least one solid carrier. Granules, e. g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas, and products of vegetable origin, such as cereal meal, tree bark meal, wood meal and nutshell meal, cellulose powders and other solid carriers.

Examples for composition types are:

1. Composition Types for Dilution with Water

i) Water-Soluble Concentrates (SL, LS)

10 parts by weight of a salt according to the invention are dissolved in 90 parts by weight of water or in a water-soluble solvent. As an alternative, wetting agents or other auxiliaries are added. The active substance dissolves upon dilution with water. In this way, a composition having a content of 10% by weight of active substance is obtained.

ii) Dispersible Concentrates (DC)

20 parts by weight of a salt according to the invention are dissolved in 70 parts by weight of cyclohexanone with addition of 10 parts by weight of a dispersant, e. g. polyvinylpyrrolidone. Dilution with water gives a dispersion. The active substance content is 20% by weight.

iii) Emulsifiable Concentrates (EC)

15 parts by weight of a salt according to the invention are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

iv) Emulsions (EW, EO, ES)

25 parts by weight of a salt according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

v) Suspensions (SC, OD, FS)

In an agitated ball mill, 20 parts by weight of a salt according to the invention are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-Dispersible Granules and Water-Soluble Granules (WG, SG)

50 parts by weight of a salt according to the invention are ground finely with addition of 50 parts by weight of dispersants and wetting agents and prepared as water-dispersible or water-soluble granules by means of technical appliances (e. g. extrusion, spray tower, fluidized bed). Dilution with water gives a stable dispersion or solution of the active substance. The composition has an active substance content of 50% by weight.

vii) Water-Dispersible Powders and Water-Soluble Powders (WP, SP, SS, WS)

75 parts by weight of a salt according to the invention are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of a salt according to the invention are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition Types to be Applied Undiluted

ix) Dustable Powders (DP, DS)

5 parts by weight of a salt according to the invention are ground finely and mixed intimately with 95 parts by weight of finely divided kaolin. This gives a dustable composition having an active substance content of 5% by weight.

x) Granules (GR, FG, GG, MG)

0.5 parts by weight of a salt according to the invention is ground finely and associated with 99.5 parts by weight of carriers. Current methods are extrusion, spray-drying or the fluidized bed. This gives granules to be applied undiluted having an active substance content of 0.5% by weight.

xi) ULV Solutions (UL)

10 parts by weight of a salt according to the invention are dissolved in 90 parts by weight of an organic solvent, e. g. xylene. This gives a composition to be applied undiluted having an active substance content of 10% by weight.

The agrochemical compositions generally comprise between 0.01 and 95%, preferably between 0.1 and 90%, most preferably between 0.5 and 90%, by weight of salts according to the invention. These active substances are employed in a purity of from 90% to 100%, preferably from 95% to 100% (according to NMR spectrum). Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations.

In another embodiment of this invention, the agrochemical composition comprising 10-70% by weight of salts according to this invention, 30-90% by weight of water, optionally at least one further pesticide, and optionally up to 10% by weight of auxiliaries, wherein the amount of all components adds up to 100% by weight.

Application can be carried out before or during sowing. Methods for applying or treating agrochemical compounds and compositions thereof, respectively, on to plant propagation material, especially seeds, are known in the art, and include dressing, coating, pelleting, dusting, soaking and in-furrow application methods of the propagation material. In a preferred embodiment, the compounds or the compositions thereof, respectively, are applied on to the plant propagation material by a method such that germination is not induced, e. g. by seed dressing, pelleting, coating and dusting. In a preferred embodiment, a suspension-type (FS) composition is used for seed treatment. Typically, a FS composition may comprise 1-800 g/l of active substance, 1-200 g/I Surfactant, 0 to 200 g/I antifreezing agent, 0 to 400 g/l of binder, 0 to 200 g/l of a pigment and up to 1 liter of a solvent, preferably water.

The active substances can be used as such or in the form of their compositions, e. g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the active substances according to the invention. Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water. The active substance concentrations in the ready-to-use preparations can be varied within relatively wide ranges. In general, they are from 0.0001 to 10%, preferably from 0.001 to 1% by weight of active substance. The active substances may also be used successfully in the ultra-low-volume process (ULV), it being possible to apply compositions comprising over 95% by weight of active substance, or even to apply the active substance without additives.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha. In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required. When used in the protection of materials or stored products, the amount of active substance applied depends on the kind of application area and on the desired effect. Amounts customarily applied in the protection of materials are, e. g., 0.001 g to 2 kg, preferably 0.005 g to 1 kg, of active substance per cubic meter of treated material.

Various types of oils, wetters, adjuvants, herbicides, bactericides, other fungicides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1. Adjuvants which can be used are in particular organic modified polysiloxanes such as Break Thru S 240®; alcohol alkoxylates such as Atplus 245®, Atplus MBA 1303®, Plurafac LF 300® and Lutensol ON 30®; EO/PO block polymers, e. g. Pluronic RPE 2035® and Genapol B®; alcohol ethoxylates such as Lutensol XP 80®; and dioctyl sulfosuccinate sodium such as Leophen RA®.

The salts according to the invention can also be present together with other active substances, e. g. with herbicides, insecticides, growth regulators, fungicides or else with fertilizers, as pre-mix or, if appropriate, not until immediately prior to use (tank mix).

The present invention also relates to a method of combating harmful insects and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of the agrochemical formulation according to the invention.

The present invention further relates to a method of controlling undesired vegetation, which comprises allowing a herbicidal effective amount of the agrochemical formulation according to the invention to act on plants, their habitat or on seed of said plants.

The present invention further relates to seed comprising the salt according to the invention. Preferably, the seed is coated with an agrochemical formulation comprising the salt according to the invention.

The salts according to the invention show a lower volatility. These salts are easily prepared starting from inexpensive, industrially available compounds, which are easy to handle.

The invention is further illustrated but not limited by the following examples. Greenhouse and growth chamber treatments are typically applied to the test substrate using a laboratory track sprayer using a 95015E nozzle (source: Spraying Systems/TeeJet) and a 146 L/ha spray volume.

### EXAMPLES

Dicamba acid: A technical quality of the herbicide comprising 90 wt. % dicamba free acid. Oliqo-N,N-Bis(3-aminopropyl)methylamine (MPPI): formula as below, wherein n is 9-22.

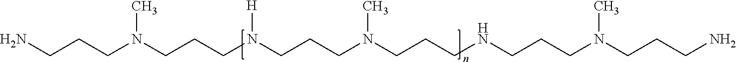

Example 1-Preparation of Salts

Salts were prepared comprising dicamba as pesticide anion and various polyamine cations. A known quantity of dicamba acid was suspended in water while stirring. The suspension was titrated with polyamine to a pH of 7.0 to 8.0 until all solids were dissolved and the salts have formed. Additional water was added to adjust the desired concentration of dicamba (600 g/l). Table 1 lists the details of the final compositions. The dicamba concentration was 48.4 wt. % in each case. The water concentration added up to 100 wt. % in each case. The quality of the polyamine is given in parenthesis. N,N-Bis(3-aminopropyl)methylamine (100%) refers to BAPMA hereinafter and Oligo-N,N-Bis(3-aminopropyl)methylamine (100%) refers to MPPI hereinafter. It was demonstrated, that all tested salts have a very good solubility in water, i.e. that dicamba salts are soluble up to at least 600 g/I.

TABLE 1
Dicamba salts

| | | Concentration |
|---|---|---|
| Entry | Type of polyamine cation | (w/w %) |
| 1 | N,N-Bis(3-aminopropyl) | 12.5 |
| | methylamine (100%) | |
| 2 | Oligo-N,N-Bis(3-aminopropyl) | 18.4 |
| | methylamine (100%) | |

Entry 1 is not part of this invention.

Example 2-Volatility of Dicamba Determined in Open Petri Dish

A dicamba sample of the aqueous solutions of dicamba (600 g/l) as prepared in Example 1 (Table 1) was diluted with distilled water in a ratio of 1:50. To help spreading of the samples uni-formly on the surface of the plate, Silwet L-77 was added (0.1 wt. %). A total of 300 μl of this diluted sample was applied per Petri dish (diameter 5 cm). The dishes were kept at an environment chamber (Barnstead Environ-Cab Lab-line 680A) with forced air flow (air vent out) up to one month at 50° C. and 30% humidity. Afterwards the plates were extracted with acetic acid/methanol and the pesticide quantified by HPLC (Columbus C18 column) to determine the volatile loss of dicamba acid. Thus, it was demonstrated, that the salt of dicamba in the present invention had a reduced volatility compared to commercial dicamba salt formulations.

TABLE 2
Petri dish volatility of Dicamba salts

| | Type of | Volatility | Volatility |
|---|---|---|---|
| | polyamine | after 2 weeks | after 4 weeks |
| Entry | cation | (wt % loss) | (wt % loss) |
| 1 | BAPMA | 7.17 | 9.83 |
| 2 | MPPI | 1.33 | 3.83 |

Entry 1 is not part of this invention.

Example 3-Secondary Loss of Dicamba with Quantitative Humidome Study

A quantitative humidome study provides a measurement of relative secondary loss in a dynam-ic, contained environment via air sampling and quantitative analysis (an indication of potential volatile or particulate loss from a treated substrate; usually measured as the amount of dicamba captured in an air sampling filter per air volume or ng/m³).

The method of a quantitative humidome study utilized a treated substrate (e.g. glass, soil, potting mix or plants) placed in a plastic tray covered with a clear plastic humidome (overall size 25 cm wide×50 cm long×20 cm tall; source: Hummert) fitted with an air sampling filter cassette (fiberglass and cotton pad filter media; source: SKC) connected to a vacuum pump (flow rate: 2 L/min). Individual humidomes representing different study treatments and replicates were placed in a controlled growth chamber environment (typical temperature at 35° C. and 25 to 40% Relative Humidity).

After 24 hours, filters were collected, extracted and analyzed for dicamba content using GC-MS. The total amount of dicamba captured was then divided by total volume of the air flow through the filter to calculate total dicamba (ng), average dicamba concentration ng/m³ and % relative loss or improvement compared to a standard treatment. Lower loss of dicamba indicates a better or improved secondary loss profile for a given treatment.

Table 3 details a quantitative humidome study conducted in a growth chamber to compare secondary loss profiles of selected dicamba candidates. All treatments included 0.25% v/v non-ionic surfactant Induce from Helena Chemical and the substrate media was 8 glass petri plates with total area 594 cm². Aqueous solutions of the candidates were prepared by dissolving the components as indicated in Table 3 in water at room temperature while stirring. The samples were clear solutions. They remained clear solutions after storage for at least four weeks at room temperature.

TABLE 3
secondary loss of dicamba with
quantitative humidome study

| Type | | | % reduction |
|---|---|---|---|
| of poly- | Dicamba | Polyamine | in secondary |
| amine | Rate | rate | loss relative to |
| cation | (g ae/ha) | (g ae/ha) | Dicamba-BAPMA |
| BAPMA | 560 | 148 | — |
| MPPI | 560 | 231 | 76 |
| MPPI | 560 | 213 | 64 |

According to the results in Table 3, the formulations of the present invention provided a significant reduction in potential dicamba secondary loss relative to the dicamba-BAPMA reference.

Example 4-Secondary Loss of Dicamba with Bioassay Humidome Study

A bioassay humidome study provides a measurement of secondary loss in a static, contained environment using sensitive soybean plants as a biological indicator (an indication of potential volatile or particulate loss from a treated substrate; usually measured as a visual 0-100 percent assessment of soybean injury where more injury indicates higher potential loss (exposure)).

The method of a bioassay humidome study utilized a treated substrate (e.g. glass, soil, potting mix or plants) placed in a plastic tray covered with a clear plastic humidome (overall size 25 cm wide×50 cm long×20 cm tall; source: Hummert) along with 2 dicamba sensitive soybean plants (1-2 true leaves). Individual humidome representing different study treatments and replicates were placed in a greenhouse environment (with a typical diurnal temperature range of 25 to 40° C. and 75 to 98% Relative Humidity).

After 18 to 24 hours, the sensitive soybean plants were removed from the humidomes and placed on a greenhouse bench for observation and visual response or injury assessment over 2-3 weeks period. The level of injury to soybean plants is an indirect measurement of amount of dicamba exposure from treated substrate. Lower injury to plants indicates a relatively better or improved secondary loss treatment profile.

Table 4 details a bioassay humidome study conducted in a greenhouse to compare secondary loss profiles of selected dicamba candidates. All treatments included 0.25% v/v non-ionic surfactant Induce from Helena Chemical and the substrate media was 2 glass plates with total area 620 cm². Aqueous solutions of the candidates were prepared by dissolving the components as indicated in Table 4 in water at room temperature while stirring. The samples were clear solutions. They remained clear solutions after storage for at least four weeks at room temperature.

TABLE 4
secondary loss of dicamba with
bioassay humidome study

| Type | | | % reduction |
|---|---|---|---|
| of poly- | Dicamba | Polyamine | in secondary |
| amine | Rate | rate | loss relative to |
| cation | (g ae/ha) | (g ae/ha) | Dicamba-BAPMA |
| BAPMA | 1120 | 296 | — |
| MPPI | 1120 | 462 | 41 |
| MPPI | 1120 | 426 | 45 |

According to the results in Table 4, the experimental formulations provided a significant reduction in soybean injury related to dicamba secondary loss relative to the dicamba-BAPMA reference.

1. A salt comprising an anionic pesticide comprising a carboxylic acid group, and a cationic polyamine of the formula (B) 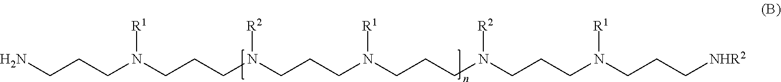
wherein R¹, R² are each independently H or C₁-C₆ alkyl,
n is between 5 to 40.

2. The salt according to claim 1, wherein the anionic pesticide is a herbicide selected from the group consisting of aromatic acid herbicides, phenoxycarboxylic acid herbicides, and organophosphorus herbicides comprising a carboxylic acid group.

3. The salt according to claim 2, wherein the anionic pesticide is a herbicide selected from the group consisting of dicamba, glyphosate, glufosinate, L-glufosinate, 2,4-D, aminopyralid, aminocyclopyrachlor, MCPA, and a mixture thereof.

4. The salt according to claim 3, wherein the anionic pesticide is dicamba, 2,4-D, or MCPA.

5. The salt according to claim 3, wherein the anionic pesticide is dicamba, glyphosate, or a mixture thereof.

6. The salt according to claim 3, wherein the anionic pesticide is dicamba.

7. The salt according to claim 1, wherein R¹ and R² are each independently H or methyl, n is from 9 to 22.

8. The salt according to 1, wherein R¹ is methyl and R² is H, n is from 9 to 22.

9. An agrochemical composition comprising at least one salt according to claim 1.

10. An agrochemical composition, comprising:
1) 10-70 wt. % of at least one salt according to claim 1,
2) 30-90 wt. % water,
3) optionally at least one further pesticide, and
4) optionally up to 10 wt. % auxiliaries, wherein the amount of all components adds up to 100 wt. %.

11. A method for preparing the salt according to claim 1 comprising combining the pesticide in its neutral form or as salt, and the polyamine in its neutral form or as salt.

12. The method according to claim 11, wherein the pesticide and the polyamine are combined in water.

13. A method of combating harmful insects and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of the salt according to claim 7.

14. A method of controlling undesired vegetation, which comprises allowing an herbicidal effective amount of the agrochemical formulation according to claim 9 to act on plants, their habitat or on seed of said plants.

15. A seed comprising the salt according to claim 1.
